(19) United States
(12) Patent Application Publication
(10) Pub. No.: US 2026/0175328 A1
(43) Pub. Date: Jun. 25, 2026

(54) FIBER BASED LASER WELDING SYSTEM EMPLOYING A QUICK RELEASE WIRE FEED MECHANISM

(71) Applicants: James Vig Sherrill, Kingston, TN (US); Christopher R. Wingo, Temecula, CA (US); Steven W. Smyrski, Santa Monica, CA (US)

(72) Inventors: James Vig Sherrill, Kingston, TN (US); Christopher R. Wingo, Temecula, CA (US); Steven W. Smyrski, Santa Monica, CA (US)

(21) Appl. No.: 19/429,399

(22) Filed: Dec. 22, 2025

Related U.S. Application Data
(60) Provisional application No. 63/738,237, filed on Dec. 23, 2024.
(60) Provisional application No. 63/808,309, filed on May 19, 2025.
(60) Provisional application No. 63/930,091, filed on Dec. 3, 2025.

(51) Int. Cl. B23K 26/70; B23K 26/00; B23K 26/035; B23K 26/064; B23K 26/12; B23K 26/21

(52) U.S. Cl. CPC B23K 26/702; B23K 26/0096; B23K 26/035; B23K 26/0648; B23K 26/123; B23K 26/21

(57) ABSTRACT

A laser welding system for welding a target workpiece arrangement is provided. The design includes a quick release wire feed mechanism for use with a welding gun and includes a shaft, an adapter configured to fit with and connect to a tab provided on the welding gun, wherein the adapter comprises at least one open region configured to receive the shaft, a support bracket configured to fit with the adapter and maintain wire feed hardware, and a release lever attached to the shaft. The release lever and the shaft secure the support bracket to the adapter.

The present application claims priority based on U.S. Provisional Patent Application Ser. No. 63/738,237, filed Dec. 23, 2024 and entitled “Fiber Based Laser Welding System,” inventors James Vig Sherrill, et al., U.S. Provisional Patent Application Ser. No. 63/808,309, filed May 19, 2025 and entitled “Fiber Based Laser Welding System,” inventors James Vig Sherrill, et al., and U.S. Provisional Patent Application Ser. No. 63/930,091, filed Dec. 3, 2025 and entitled “Enhanced Laser Welding Apparatus,” inventors James Vig Sherrill, et al., the entirety of all of which are incorporated herein by reference.

### BACKGROUND OF THE INVENTION

### Field of the Invention

The present invention generally relates to the field of welding, and more particularly to laser welding and enhanced operation of devices employed in laser welding.

### Description of the Related Art

A fiber laser welding system uses a fiber laser to perform welding tasks with high precision and efficiency. The system generates a highly focused, narrow, intense beam of coherent light onto the target metal rapidly heating the target metal to a liquid or plasma state. The fiber laser beam is typically created by exciting a laser-active optical medium, such as a rare-earth-doped optical fiber, using a pump laser, usually a solid-state diode laser. The laser may be pulsed from 0 to 100% duty cycles rapidly, typically up to many MHz. Such a device allows for output power control, reducing the overall heating of the target weld, as well as other advantages over previously available welding systems.

The laser typically employs a “guide” beam that indicates where the striking point of the laser, enabling the user to locate the spot where the laser will strike before welding commences. Once initiated, concentrated laser beam rapidly heats and melts the metal at the weld joint. The small beam size allows for deep penetration with minimal heating to the surrounding material. As the laser beam is moved along the metal it creates a molten pool of metal that fuses workpieces together. The ability to precisely control the power, size and focal point of the laser beam greatly provides advantages previously unavailable, including an increase in speed of welding with minimal distortion to the remainder of the metal.

A handheld laser welding gun is typically provided. Previous handheld laser welding guns include a nozzle used to direct a shielding gas, such as argon or nitrogen, around the welding area to protect the weld from contamination and oxidation. Such guns include a safety interlock wherein the tip or shroud of the gun, usually made of copper or bronze, must be touching the metal to be welded. The metal to be welded is in turn electrically connected to complete a circuit, where the circuit being closed allows the laser to fire. In this manner the laser cannot fire unless the nozzle of the laser welding gun is physically contacting the target metal.

While the typical interlock system is generally effective, such a system can be intentionally or negligently defeated. In a case where the laser nozzle is touching the target but angled away so that the laser beam is directed away from the target or the target metal, the interlock is still electrically connected and does not prevent the laser from firing. This case, which can again be either intentional or negligent, creates a significant, serious, and potentially deadly hazard to anything in the path of the beam. The situation described can also occur when, for example, a welder adhering to recommended safety procedures attempts to execute a laser weld over a sharp bend or end point. While the tip of the welding gun is in contact with the sharp bend or end point and the interlock is still electrically connected, the beam is transmitted into open space and away from the workpiece.

Another issue with current laser weld devices is that in some cases an additional wire feed is employed to add material to the weld. The wire distributed to the weld region and employed in the laser welding is typically distributed at a constant rate when the laser weld gun is operating. Constant rate wire distribution can be inefficient, particularly when welds need to be performed multiple times in a region, or when the welder proceeds at either a significantly faster or significantly slower rate than an average welder.

Issues with previous welding systems include the ability to provide a relatively stable and generally uniform application of energy when operating under different situations. Laser welding devices provide a single laser beam that can provide too much energy intensity when transmitted as a single, stationary beam. To address this issue, laser welding devices have oscillated the single beam over a certain range at a particular frequency, commonly called a “wobble.” Such systems can yield uneven beam transmission over the range illuminated wherein the system directs more energy to some locations than others. For example, when such a system provides a sinusoidal laser waveform, energy application becomes stronger at some locations on the target while other locations receive less energy. The beam does not distribute energy equally across the target zone. The result of this effect is an uneven or nonuniform weld in some cases, which is undesirable.

One additional issue with modern welding devices, particularly laser welding devices, is heating. Such devices tend to be very heavy, which can provide difficulties moving or repositioning the welding device. Conventional heating of such devices has called for the circulation of air or water through the relevant laser welder components, particularly the laser diodes. The use of air to cool components of a laser welding device has in the past called for heat sinks to draw heat away from the laser diodes. Such heat sinks can be heavy, constructed of copper or aluminum or a combination thereof. These heat sinks can in some cases account for over 80 percent of the overall weight of the device. Water cooling apparatus, and the weight of water used, also results in a heavy welding device. These previous cooling solutions have resulted in a device difficult to move and reposition.

A further issue with previous designs relates to overall safety concerns. Certain system failures can occur and in short, a device, and particularly a device involving high powered laser energy, cannot be too safe. While the presence of safeguards can be helpful, if such safeguards are inadequate or fail in any way, even momentarily, alternate safeguards may provide additional benefits.

Certain laser welding devices also suffer from component wear issues. Possibly the most notable wear issue is in the optical path including any and all lenses employed. The level of energy transmitted through such lenses is significant and such lenses can wear out or degrade rapidly as compared with other components in the device. Lenses closer to the output arrangement tend to suffer degradation most, as they tend to receive the highest power level. In the past such lenses have received energy at a location, such as the center of the lens, and over time have failed, requiring replacement. Replacement can be time consuming and expensive.

Handheld laser welders commonly include a wire-feeding system to support filler wire delivery during welding operations. However, the wire-feeder tip assembly is often bulky, protruding, and cumbersome when filler wire is not required. In existing systems, the wire-feeder tip assembly is typically permanently attached to the gun by a rigid screw-on bracket. A Bowden wire-feeder tube is integrated into the main laser gun cable bundle, preventing easy removal. If the user wishes to weld without wire, the feeder tip assembly becomes an obstruction or must be manually tied back, which is undesirable, unsafe, and interferes with control of the welding gun. It would be advantageous to have a wire-feeder assembly that can be removed quickly, without tools, allowing neat and secure disconnection of the Bowden feeder cable when the assembly is not in use.

It would therefore be beneficial to offer a laser welding system that addresses previous issues with laser welding, such as safety issues in a typical laser welding setting that require a laser welding gun with a nozzle that employs an interlock system that operates based on physical contact with a metal workpiece.

### SUMMARY OF THE INVENTION

The present design includes a laser welding system for welding a target workpiece arrangement comprising a laser beam transmitter configured to transmit a laser beam at an energy level, a guide beam transmitter configured to transmit a guide beam, a sensor configured to sense light transmitted and reflected from the target workpiece arrangement, and a controller configured to decrease the energy level of the laser beam when the sensor senses the light received at a time greater than a threshold acceptable time level.

According to a further embodiment, there is provided a laser welding system for welding a target workpiece arrangement comprising a laser beam transmitter configured to transmit a laser beam at an energy level, a sensor configured to sense an attribute of the target workpiece arrangement when exposed to one of the laser beam transmitted toward the target workpiece arrangement and an energy emission transmitted toward the target workpiece arrangement, and a controller configured to decrease the energy level of the laser beam when the sensor senses the attribute having a value below a threshold attribute level. The controller is further configured to decrease the energy level of the laser beam irrespective of physical contact between the laser beam transmitter and the target workpiece arrangement.

According to another embodiment of the present design, there is provided a laser welding system comprising a laser beam transmitter configured to transmit a laser beam at an energy level toward a workpiece arrangement, a sensor configured to sense an attribute of the target workpiece arrangement when the target workpiece arrangement is exposed to one of the laser beam contacting the target workpiece arrangement, and an energy emission transmitted toward the target workpiece arrangement, and a controller configured to decrease the transmission energy level of the laser beam transmitter when the sensor senses the attribute at a value outside an acceptable threshold window. The controller is further configured to decrease the energy level of the laser beam irrespective of physical contact between the laser beam transmitter and the target workpiece arrangement.

According to an additional embodiment of the present design, there is provided a laser welding system for welding a target workpiece arrangement, comprising a laser beam transmitter configured to provide a laser beam, a rotatable reflective surface configured to receive the laser beam and direct the laser beam toward the target workpiece arrangement, and a controller configured to provide a triangular wave control command controlling the rotatable reflective surface to rotate and reflect laser energy toward the target workpiece arrangement in a triangular wave pattern.

According to a further embodiment, there is provided a laser welding system for welding a target workpiece arrangement comprising a laser beam transmitter configured to provide a laser beam a rotatable reflective surface configured to receive the laser beam and direct the laser beam toward the target workpiece arrangement, and a controller configured to provide a triangular wave control command controlling the rotatable reflective surface to rotate and reflect laser energy linearly in a back and forth manner toward the target workpiece arrangement.

According to another embodiment, there is provided a laser beam transmission system comprising a plurality of laser diodes and an arrangement of graphene foam positioned proximate at least one laser diode.

According to yet another embodiment, there is provided a laser welding system for welding a target workpiece arrangement, comprising a laser beam transmitter configured to provide a laser beam, an audio receiver, and a controller configured to receive audio signals from the audio receiver, compare said audio signals with a predetermined audio profile, and command the laser beam transmitter from transmitting the laser beam when the comparison indicates the laser beam is not adequately striking the target workpiece. In one embodiment, the laser welding system further comprises a visual sensor configured to sense a visual attribute associated with the laser beam including but not limited to a plume or presence or absence of the workpiece and turn off the laser transmitter when the controller determines the visual attribute is deficient.

According an additional embodiment of the present design, there is provided a laser welding system for welding a target workpiece arrangement comprising a laser transmitter configured to provide laser energy and a laser welding head configured to receive the laser energy from the laser transmitter and provide a laser beam toward the target workpiece arrangement. The laser welding head comprises a protective barrier lens and the laser welding head is configured to provide the laser beam through a noncentered position of the protective barrier lens.

According to a further embodiment of the present design, there is provided a laser welding system for welding a target workpiece arrangement comprising a laser transmitter configured to provide laser energy, a controller configured to control laser energy transmission, and a laser welding head configured to receive the laser energy from the laser transmitter and commands from the controller and provide a laser beam toward the target workpiece arrangement. The laser welding head comprises a protective barrier lens and the laser welding head is configured to provide the laser beam through an offset from center position of the protective barrier lens.

According to another embodiment, there is provided a laser welding system for welding a target workpiece arrangement comprising a laser transmitter configured to provide laser energy, a wire feed mechanism, and a laser welding gun configured to receive the laser energy from the laser transmitter comprising a dual mode trigger configured to control transmission of a laser beam from the laser welding gun and control feeding of wire by the wire feed mechanism.

According to a further embodiment, there is provided a quick release wire feed mechanism for use with a welding gun, comprising an adapter configured to fit with and connect to a tab provided on the welding gun, wherein the adapter comprises a C-shaped or U-shaped tongue arrangement configured to receive a shaft, a support bracket configured to fit with the adapter, and a cam lock release mechanism comprising the shaft, the cam lock release mechanism configured to secure the support bracket to the adapter using the shaft. The support bracket connects to wire feed hardware connected to a first removable Bowden cable connected to a fixed Bowden cable by a Bowden coupling.

According to a further embodiment, there is provided a quick release wire feed mechanism for use with a welding gun, comprising a shaft, an adapter configured to fit with and connect to a tab provided on the welding gun, wherein the adapter comprises at least one open region configured to receive the shaft, a support bracket configured to fit with the adapter and maintain wire feed hardware, and a release lever attached to the shaft, the release lever and the shaft configured to secure the support bracket to the adapter.

The feed hardware is joinable to a first removable cable connected to a fixed cable by a coupling, and the mechanism comprises a tightening element configured to secure the adapter to the tab. The shaft comprises an end piece, wherein the shaft fits through openings in the support bracket and within a first open region in the adapter, enabling fixing the shaft in the first open region and securing the support bracket to the adapter. The wire feed hardware comprises a tubular member configured to receive wire, the tubular member passing through abutting elements positionable adjacent sides of the support element. The release member comprises a cam tightening element joined to the shaft and configured to draw the shaft forward when engaged and release tension on the shaft when disengaged. The mechanism may also include a Y-shaped element joined to the welding gun, wherein one branch of the Y-shaped element joins to the coupling and another branch of the Y-shaped element receives gas and passes the gas to the welding gun.

According to an additional embodiment, there is provided a quick release wire feed mechanism for use with a welding gun having a tab on a bottom side, comprising an adapter comprising a C or U shaped region, the adapter configured to fit with and connect to the tab, a support bracket configured to fit with the adapter and maintain wire feed hardware, and a release mechanism comprising a shaft having an end and a release lever attached to the shaft, the release lever when engaged configured to pull the end of the shaft, securing the support bracket to the adapter.

According to a further embodiment, there is provided a quick release wire feed mechanism joinable to a tab on a welding gun comprising an adapter configured to fit with and connect to the tab, the adapter comprising a C or U shaped region, a support bracket configured to fit with the adapter and maintain wire feed hardware, and a cam release mechanism comprising a shaft configured to fit within the C or U shaped region and a release lever having an end element affixed thereto, the release lever and the shaft configured to releasably secure the support bracket to the adapter.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 is a representation of a typical prior art laser welding system;

FIG. 2 illustrates a prior art laser welding handpiece or gun;

FIG. 3 shows a conceptual representation of one embodiment according to the present design;

FIG. 4 is a flowchart of operation of one aspect of the present design;

FIG. 5 illustrates an alternate version of a laser welding handpiece or gun including an additional trigger.

FIG. 6 shows a sinusoidal waveform previously employed to control laser beam “wobble;”

FIG. 7 is the energy level distribution of a laser beam transmission for a scan 10 millimeters wide, i.e. a wobble of plus and minus five millimeters controlled using a sinusoidal scan similar to that of FIG. 6;

FIG. 8 shows a triangular waveform used in the present design;

FIG. 9 represents an energy level distribution of a laser beam transmission for a scan 10 millimeters wide, i.e. a wobble of plus and minus five millimeters controlled using a triangular wave scan similar to that of FIG. 8;

FIG. 10 illustrates a conceptual version of a heatsink arrangement usable or typical of use in previous laser welding systems;

FIG. 11 is a design employing graphene foam to address heat and weight issues;

FIG. 12 illustrates a representation of welding of a workpiece with audio monitoring attributes.

FIG. 13A shows a rotatable protective lens employable in the present design in an initial orientation;

FIG. 13B is the rotatable protective lens with a degradation represented, such as dirt, grime, etc.;

FIG. 13C illustrates the rotatable protective lens with rotated to a first alternate position;

FIG. 14 is a cart configuration for use with the laser welding device disclosed herein that functions as a shipping container;

FIG. 15 illustrates programmable start up time and power level of the laser;

FIG. 16 shows the programmable power down sequence of the system when the user releases or deactivates the trigger;

FIG. 17 illustrates a laser welding gun employing a quick release mechanism for use with wire feed hardware;

FIG. 18 is an adapter used with the quick release mechanism of FIG. 17;

FIG. 19 is a first alternate view of the quick release mechanism of FIG. 17 showing the wire feed quick release hardware secured and in place; and

FIG. 20 is a second alternate view of the quick release mechanism of FIG. 17 showing the wire feed quick release hardware released from the laser welding gun.

### DETAILED DESCRIPTION

In this document, the words “embodiment,” “variant,” and similar expressions refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean serving as an example, instance, or illustration. Any embodiment variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

The present fiber laser welding system uses a fiber laser to generate a highly focused, narrow, intense beam of coherent light onto target metal, rapidly heating the target metal to a liquid state. The fiber laser beam is typically created by exciting a laser-active optical medium, such as a rare-earth-doped optical fiber, using a pump laser, typically a solid-state diode laser. Laser welders offer significant advantages over previously available TIG and MIG welding systems, including ease of use and a high level of precision. A laser can be pulsed anywhere between 0 and 100% duty cycle very quickly, up to many megahertz, because of the operation of the laser diode. Such pulsing provides output power control and a reduction in the overall heating of a large weld among other benefits. A typical laser wavelength is around 1050-nanometers, a value outside the visible spectrum. Green lasers in the 535-nanometer wavelength range are also available in laser welding applications.

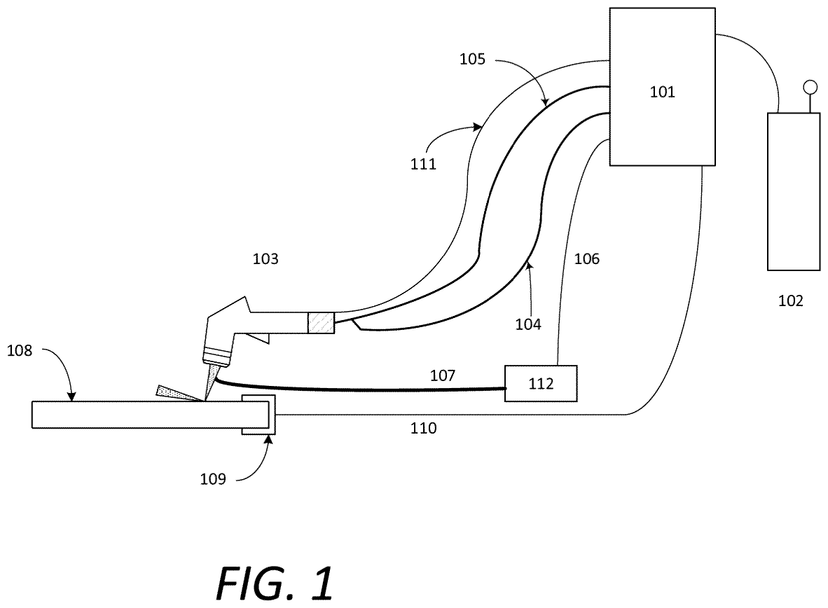

FIG. 1 shows a typical laser welding arrangement. From FIG. 1, power source 101 is typically plugged into a 240V outlet and shielding gas 102 is provided either to power source 101, where it can be controlled, or directly to gun 103 via gas line 104. Control cables 105 and 106 provide control from power source 101, with control cable 106 providing control to a wire feeder 112 that feeds wire 107 for application by gun 103 to workpiece 108. Control cable 105 provides control signals to gun 103. The system provides fiber optic (QBH) cable 111 to gun 103. Workpiece connector 109 connects to workpiece 108 and workpiece clamp cable 110 provides the necessary closed loop feedback to ensure contact between gun 103 and workpiece 108. Power stops when the circuit is broken, or when physical contact between gun 103 and workpiece 108 is lost. The representation of FIG. 1 is one possible embodiment, but other embodiments with more or fewer components may be employed.

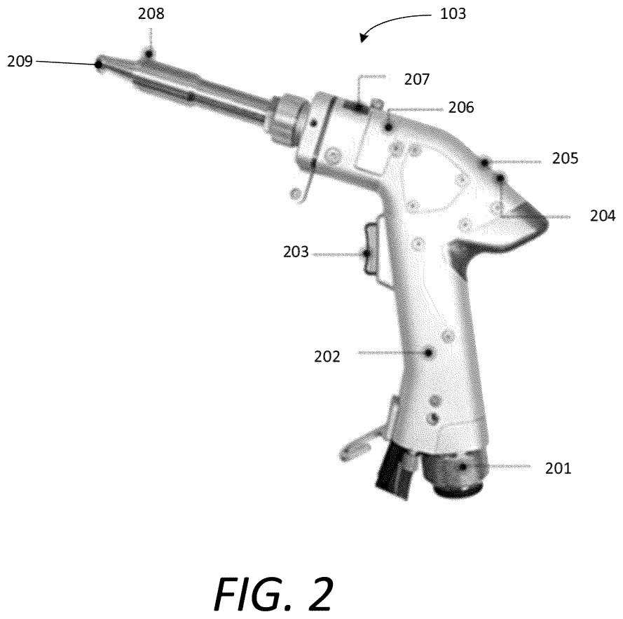

FIG. 2 is a construction of a typical laser weld gun used in systems such as shown in FIG. 1. From FIG. 2, there is provided gun 103 having an optical fiber interface 201 that may receive fiber optic cable 111, a hand hold or grip 202, and a laser switch 203. Laser switch 203 turns the laser beam for weld on and off. The embodiment shown includes a warning light 204 that may indicate inadequate conditions or may indicate a different issue, such as excessive heating depending on the implementation. Protection lamp 205 indicates the operational status of the system. Focusing mirror module 206 provides focus of the laser beam, while lower protection switch 207 allows for the lowering of the laser power level. Nozzle 208 includes copper shroud 209 at the tip.

The system typically produces a “guide” beam indicating to the user the position on the target where the laser beam will strike. The guide beam enables the user to determine the laser strike position before welding begins. This guide beam may be produced in fiber but can be produced externally. Guide beam wavelength transmits in the visible spectrum at power levels transmitted by a common laser pointer.

The laser beam passes through the flexible optical fiber to a series of lenses that can focus the beam on the surface to be welded. The focal point is typically a few millimeters from the end of the gun 103. In addition, the laser beam is typically steered in the gun by using either one or two galvanometers to provide either a line or two dimensional pattern rather than a single point. The width of the line or pattern defines the width of the laser weld.

The concentrated laser beam rapidly heats and melts the metal at the weld joint. Small beam size allows for deep penetration with minimal heating to the surrounding material. As the laser beam moves along the metal the beam creates a molten pool of metal that fuses the workpieces together. The ability to precisely control laser beam power, size and focal point increases the quality of the weld with minimal distortion to the rest of the metal.

The hand held gun 103 includes a nozzle that directs a shielding gas such as argon or nitrogen around the welding area to protect the weld from contamination and oxidation. The gun 103 and overall system employs a safety interlock wherein the tip or shroud of the gun 103, usually formed of copper or bronze, must be touching the metal to be welded. The metal to be welded is in turn connected back to power source 101 via workpiece clamp cable 111 in the embodiment of FIG. 1 to complete a circuit wherein control circuitry then allows the laser to fire. This safety interlock circuit prevents the laser from firing unless gun 103 is physically contacting or touching the target metal.

As noted, the issue with this prior arrangement is the possibility of the laser being directed away from the target metal despite gun 103 touching the target metal. This situation can occur when welding a target piece of irregular shape, such as a piece with sharp corners, or simply when the user is not holding gun 103 properly.

The present system addresses this potentially dangerous laser misdirection issue. Power source 101 typically employs a controller (not shown) that controls the various functions of the laser welding system. In one embodiment of the present design, the system and controller are configured to operate the fiber laser in a pulsed mode at a duty cycle of less than 100 percent, creating an on time and an off time. The system employs a sensor in line with a guide beam, as differentiated from the main laser beam, that reflects from the metal workpiece toward a sensor positioned typically on gun 103. The guide beam when reflected from the metal workpiece contacts the sensor and the sensor provides an indication of receipt of reflected energy to the controller. Alternately, a sensor may be employed with the laser beam and the return time of the laser beam may be sensed. If the time of flight of the laser beam is outside an acceptable threshold window or below an acceptable threshold level, the controller may halt laser beam transmission.

In this embodiment, the controller uses the off time of the duty cycle to measure the distance the beam travels based on the guide pulse. The system measures the guide beam Time-Of-Flight (TOF) to assess distance from the emitter. By way of example, if the main laser is pulsed at 1 Khz with a duty cycle of 99 percent, the main laser will be on for 990 microseconds and off for 10 microseconds. During the 10 microseconds of “off” time, the guide beam can be used to measure TOF between the time when the main laser is initially pulsed ON and when the reflection of the guide beam from the metal workpiece is received back at the sensor on gun 103. The time determination requires correcting for wire and fiber lengths as well as any other quantifiable delays and requires compensating for a reasonable estimate of the distances between the guide beam emitter and the target and the target and the sensor. If the time of guide pulse travel exceeds a threshold, i.e. if the pulse has not been reflected in less than a threshold amount of time, accounting for all delays and reasonable distance estimates, the laser is locked out and prevented from firing. The pulse of the guide beam (or measure beam) is typically made during the OFF time for the main laser, but measurement may occur at other times. The process may be repeated at the main laser duty cycle, such as every 1 millisecond in this example. The controller operates the main laser to operate only as long as the guide beam's TOF is less than a threshold time based on the estimated geometries and delays. In this embodiment determining if the laser is being operated correctly does not require firing the main beam or making a determination based on the main beam. Additionally, the circuit requirement for the interlock function becomes unnecessary, and the workpiece clamp 109 and workpiece clamp cable 110 become unnecessary.

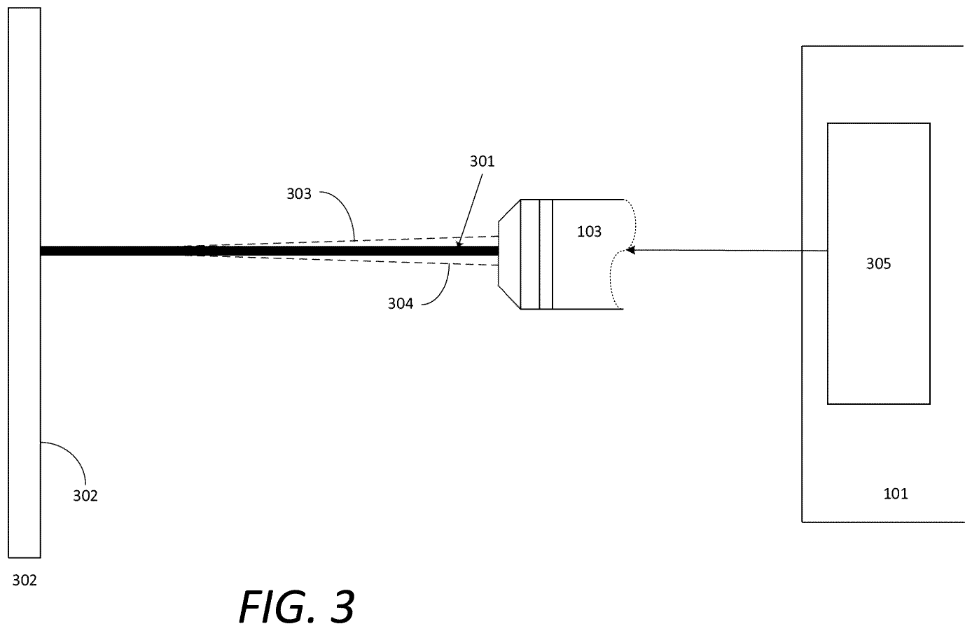

In this embodiment, the sensor should preferably be located and positioned such that diversions of the guide beam within a reasonable range do not cause issues. Multiple sensors or physically large sensors may be employed to correctly capture the reflected guide beam. They will typically be mounted behind the final lens of the laser, inside the gun. This also shields it from the laser welding debris, sparks and weld spatter. FIG. 3 conceptually illustrates the present embodiment. Gun 103 sends main beam 301 toward workpiece 302. During the OFF period of main beam 301, guide beam transmitter (not shown in this view) transmits guide beam 303 toward workpiece 302. The housing of gun 103 contains the guide beam transmitter and the guide beam transmitter may be collocated with the main beam transmitter of gun 103 or may be separate and provided on an associated device similar to a laser sight used on a rifle. Reflected beam 304 reflects from workpiece 302 and is sensed at a sensor, such as a light sensor provided in the housing or a light sensor provided outside the housing of gun 103. The time the guide beam fires is either provided to or known to controller 305. The system transmits the time the guide beam is received at the sensor to controller 305. Controller 305 then determines TOF of the guide beam and decides to stop the main beam if the time exceeds a threshold.

Threshold may be determined in any way acceptable based on the circumstances and desired functionality. For example, expected TOF may be determined based on speed of the guide beam and expected distance to the workpiece from the guide beam transmitter tip and from the workpiece to the sensor. Expected or known delays may be added. An additional buffer may be provided in addition to the expected TOF. Should the dimensions change, such as the guide beam striking the workpiece at a position materially different from the weld, the threshold may be changed. Threshold may be a single threshold, such as a not to exceed time, or a window, as in an expected time between time X and time Y. In the embodiments provided below, other thresholds, such as temperature, spectral profile, and so forth may be provided and optionally altered as described here.

As used herein, terms such as “below a threshold level” is intended broadly and may mean a time or measurable quantity higher or lower than an established measurable quantity value. In this instance, if an acceptable time of flight for a guide beam or a laser beam is X microseconds, a value “below a threshold” may include a TOF time of materially greater than X microseconds, showing the laser or guide beam transmission is taking too long and the system is to halt laser transmission. As also used herein, terms such as outside a threshold or window means any value deemed not acceptable or within an expected or acceptable range.

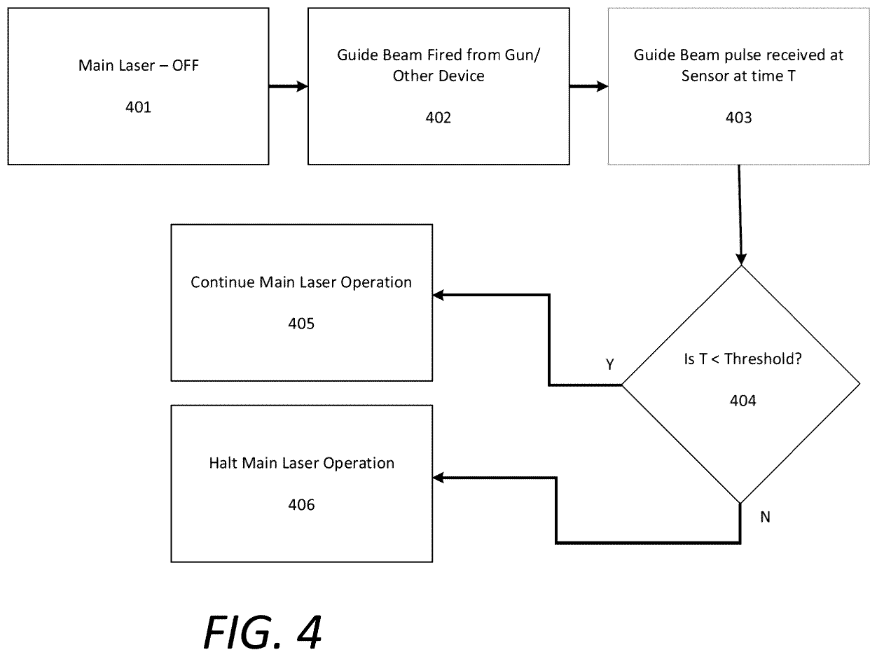

FIG. 4 is a general flowchart of the operation of this embodiment. The main laser enters an OFF period at point 401. Point 402 calls for guide beam 304 to be fired. At point 403, the guide beam pulse is received at time T at the sensor. At point 404, controller 307 receives time T from the sensor and assesses whether T is less than a predetermined threshold time based on delays, geometries, and other relevant information. If the transmission travel time of the guide pulse is less, point 405 calls for controller 307 to continue operation of the main laser. If transmission travel time is not lower than the predetermined threshold time, point 406 calls for halting main laser operation.

The guide beam travel time threshold discussed may vary depending on circumstances and may be calculated or set and must be within safety guidelines. For example, if a certain geometry would result in a greater distance between guide pulse origin and sensor receipt, that additional distance may be factored into the threshold determination. Similarly, if the transmission delay is expected under certain circumstances, that delay may affect the threshold time, and if the delay is discontinued the threshold may again change to compensate.

Another embodiment of the present design calls for operating the fiber laser in a pulsed mode at a duty cycle less than 100 percent. The system uses the OFF time to measure the distance the beam travels. If the main laser is pulsed at 1 Khz with a duty cycle of 99 percent, the main pulse will be on for 990 microseconds and off for 10 microseconds. During the 10 microsecond off time, controller 307 fires the main laser at full or a significantly reduced power for something less than the off period and the controller can measure time of flight based on receipt of the diminished main pulse. Again, a threshold is employed that corrects for wire and fiber lengths, transmission lengths, and other relevant factors and delays. If the controller determines the target metal is too far from gun 103, controller 107 locks out the main power laser and prevents the main power laser from firing.

Another method evaluates a heat response from the main laser beam. As an example, if the main laser is pulsed at 1 Khz with a duty cycle of 99 percent, the main laser is on for 990 microseconds and off for 10 microseconds. During the 10 microsecond OFF phase, the system measures heat to determine if the heat signature indicated the main laser beam struck the target workpiece. When the beam misses the target, the target temperature drops quickly. The system senses, via heat sensor, the rate of temperature drop at the target to determine whether the main beam contacted the target. Such an embodiment calls for a remote temperature sensor operating at gun 103 or otherwise in proximity to the workpiece. If target workpiece temperature is not rising or is falling as the main laser beam is firing, the main laser beam is not hitting the intended target workpiece and the controller turns the main laser beam off.

Another embodiment entails the controller issuing a calibration laser pulse with a sensor sensing the returning light intensity. If the target workpiece drops in intensity below a programmable or set threshold, the target workpiece is too far away and the main laser beam is turned off. Alternately, a sensor may be provided that monitors the spectral response of the welding. If the spectral response changes substantially during a weld, the laser is not hitting the weld and the controller turns off the main laser beam. A sensor may be provided that monitors the spectral light produced when welding. Spectral content is quite broad and peaks at the laser wavelength as a substantial amount of the laser energy is reflected by the target workpiece. When sensed spectral light is reduced or changed beyond a spectral threshold level, the main laser beam is off target and the controller may stop transmission. An appropriate spectral content sensor may be provided with or proximate gun 103. As an alternate to this embodiment, the system may monitor spectral content over a period of time and may “learn” the expected spectral content of the weld. If the spectral content changes beyond a certain range, the laser is off target and the system may halt transmission.

According to another embodiment, at the beginning of a weld, the system may obtain a sample of brightness reflected from the metal workpiece and compare the sample to a threshold value, expected value, or expected value window to determine quality of the weld. Brightness level for comparison may be any reasonable level, including but not limited to either an average or expected brightness level encountered based on the metal used in the workpiece. In one embodiment, an allowable brightness window may be established outside which the system determines weld conditions to be unacceptable. If brightness varies beyond an expected threshold or outside an allowable brightness window, the system stops the weld. Expected brightness values may be based on historical brightness data or ongoing reflection or other value identifying an acceptable weld from an unacceptable weld. While brightness may be used to determine the quality of the weld, in one embodiment brightness is assessed to determine whether the laser is striking the intended target. The threshold value or window can be determined during the weld using, for example, artificial intelligence, user inputs, or simple setting of a value or values. The system can use brightness level of the reflection encountered at the beginning of the weld as the comparison value if the brightness level materially changes, the system stops the weld. Additionally, if there is no reflection at the commencement of or after a very short time after the beginning of the weld, the system may turn off the weld.

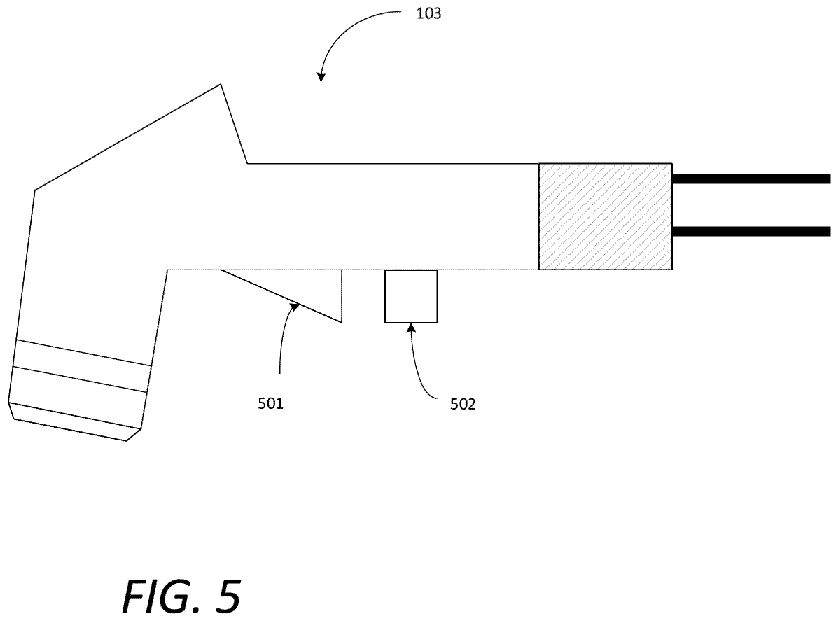

A further embodiment of the present design entails allowing the welder to distribute wire, such as wire 107, to the weld region. In such an embodiment, the wire feeder, such as wire feeder 112, is controlled not directly by power source 101, but rather by a switch provided in one embodiment on the weld gun 103. FIG. 5 illustrates weld gun 103 having trigger 501 which engages the laser and second trigger 502 which controls distribution of wire, such as via wire feeder 112. The electrical connection of second trigger 502 may be to power source 101 or directly to wire feeder 112. By employing this embodiment, the user may regulate the amount of welding wire applied which can enhance the overall weld. The triggers provided may be formed or positioned differently than as shown in FIG. 5 and one may be formed integrally with the other, such as one trigger partially formed inside the other. Trigger locking may also be provided wherein a trigger cannot be pressed when, for example, inadequate wire is available. The trigger can be either on or off or depending on the pressure applied determine the wire feed rate.

### Beam Scanning

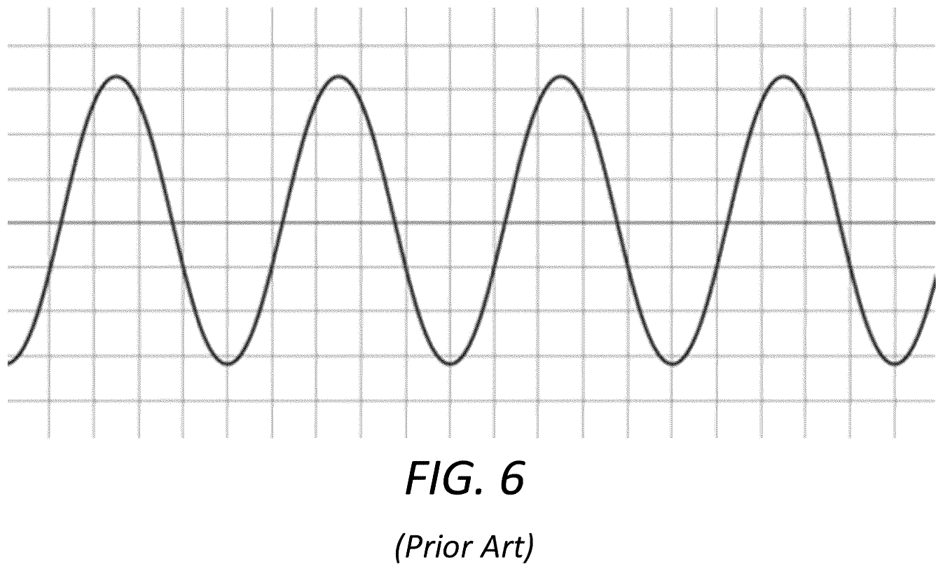

A typical laser beam scan has employed a sinusoidal waveform such as shown in FIG. 6. A single point beam results in too much energy applied to the spot, and thus previous laser welding devices have linearly oscillated the beam, where such oscillation is commonly known as “wobble” of the laser beam. In such an arrangement, controller 113 issues a scan command that provides a command to a mirror or reflective surface that rotates, providing oscillation of the single beam at a frequency across a given distance in order to spread the energy of the laser beam and laser weld. In some devices, the distance of wobble can be altered to be narrower or wider.

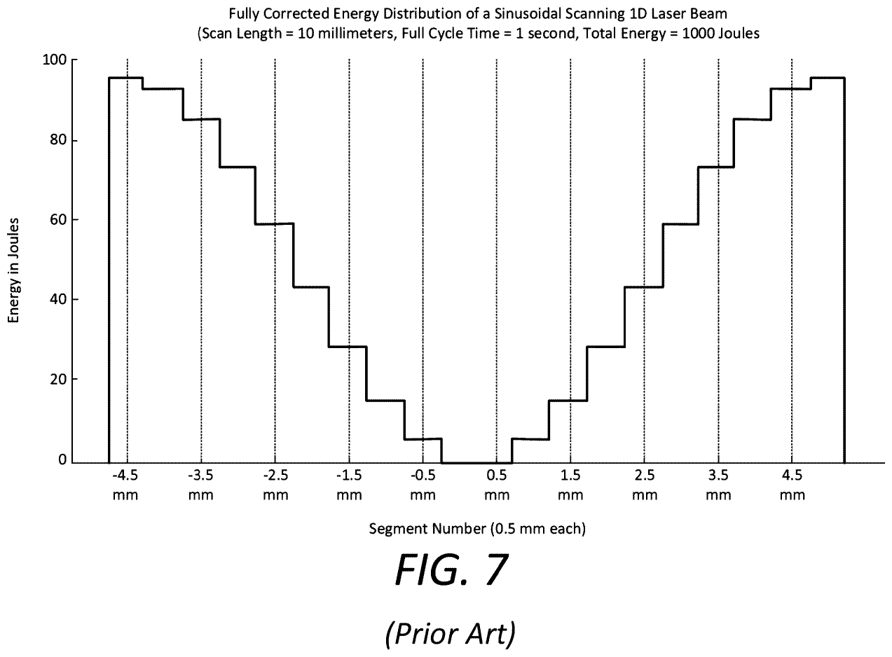

The resultant waveform provides significant energy at and near the peaks and troughs of the waveform of FIG. 6, or at or near the turning points at the edges of the wobble. FIG. 7 illustrates the energy level distribution of a laser beam transmission of 1000 Joules with a scan 10 millimeters wide, i.e. a wobble of plus and minus five millimeters controlled using a sinusoidal scan similar to that of FIG. 6. As may be seen from the distribution, energy across the scan is significantly higher at each end, which is generally undesirable. More energy is deposited where the beam moves slowest, namely at the edges of the scan.

As noted, previous designs have employed metal heatsinks to draw heat away from the laser diodes. Heat sinks inside laser welding machines have often been finned or channel-based systems that facilitate heat transfer through air or liquid cooling depending on power needs. Heat sinks are typically constructed of high conductivity materials such as aluminum or copper that transfer heat away from heat producing components such as laser diodes and have included fins and/or a block or plate shape, typically with air or water directed over the components to draw heat away.

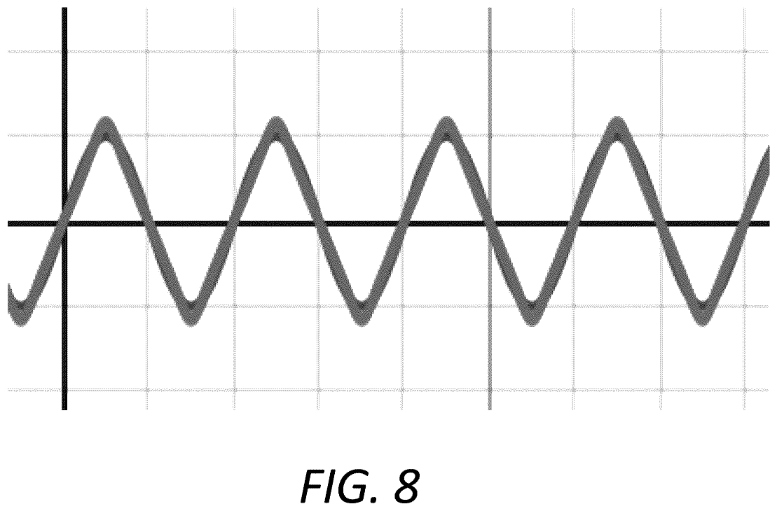

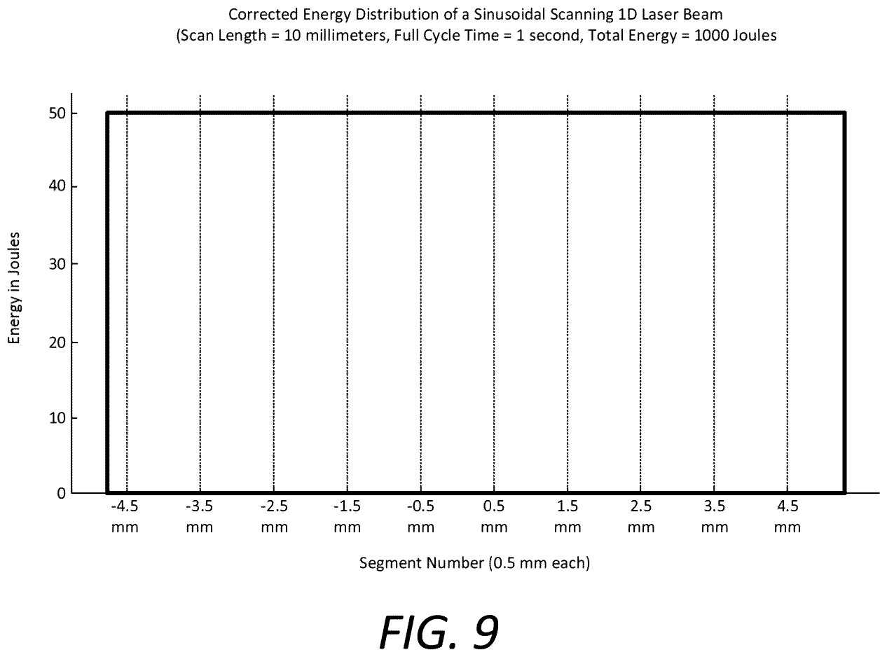

A beneficial attribute of the present design is the ability to address heating of the weld pieces more efficiently and uniformly, as well as the ability to apply more energy to specific required areas resulting from beam wobble. The present system employs a triangular waveform as shown in FIG. 8, which more evenly distributes energy across the weld and inhibits the relatively large energy levels at the edges as compared with the center of the weld. FIG. 9 shows the distribution of energy in a triangular wave which is more evenly distributed as compared with the energy profile of FIG. 7. In operation, the peak of the triangular wave is the wobble of the beam striking one side, while the valley of the triangular wave is the beam striking the other side of the wobble linear path. Crossing the zero line indicates passing through the center of the beam path. The triangular form of FIG. 8 can be altered to impart more energy in different areas as desired, such as more energy in the center of the weld, for example at plus or minus one millimeter from the center of the weld. The use of the triangular wave provides constant speed motion such that the beam spends equal time in each section, resulting in a more uniform energy distribution.

In operation, the current system may employ a mirror or reflective surface in focusing mirror module 206 which is provided in handheld gun 103. The mirror or reflective surface precesses in a side to side manner to provide the requisite wobble. In operation, the focusing mirror module 206 receives the laser beam from power source 101 and the precessing mirror or reflective surface is controlled by controller 113 or potentially a control element provided within hand held gun 103 to move the mirror or reflective surface back and forth, directing the beam toward the target. In the present design, controller 113 or another controller provided with the system commands a waveform operating the precession of the mirror or reflective surface in a triangular wave manner as discussed herein. Other waveforms may be employed, such as sawtooth waveform, or portions of waveforms combined with other waveforms, rest periods, and so forth, and/or amplitude and period of the wave may change or be changed depending on circumstances encountered and/or user input.

The beam or waveform of the beam provided may also be non-triangular in order to direct more energy at certain locations and less at others on the workpiece. The Modification of the waveform, such as by providing a programmed or preprogrammed waveform can provide for the application of more or less energy at different points on the workpiece. Such waveforms may take any desired form, may include periods where no movement occurs, i.e., pauses, or may utilize wobble to effectuate different energy level applications in a manner desired. The wobble may coordinate with the programmed waveform in that programmed waveforms may not only command beam path and waveform shape but also movement of the reflective surface and resultant wobble.

### Addressing Heating Issues

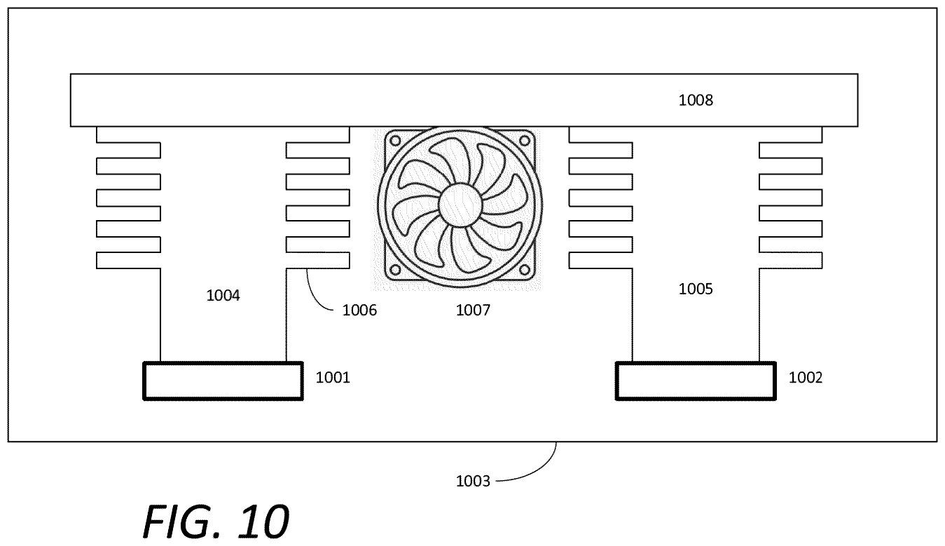

FIG. 10 illustrates one previous implementation of a heatsink arrangement. FIG. 10 is not to scale. From FIG. 10, laser diodes 1001 and 1002 are positioned within enclosure 1003. Heat sinks 1004 and 1005 have fins including fin 1006. Fan 1007 is provided that circulates air over the fins including fin 1006. Optional interconnect element 1008 is shown to further assist in the distribution of heat.

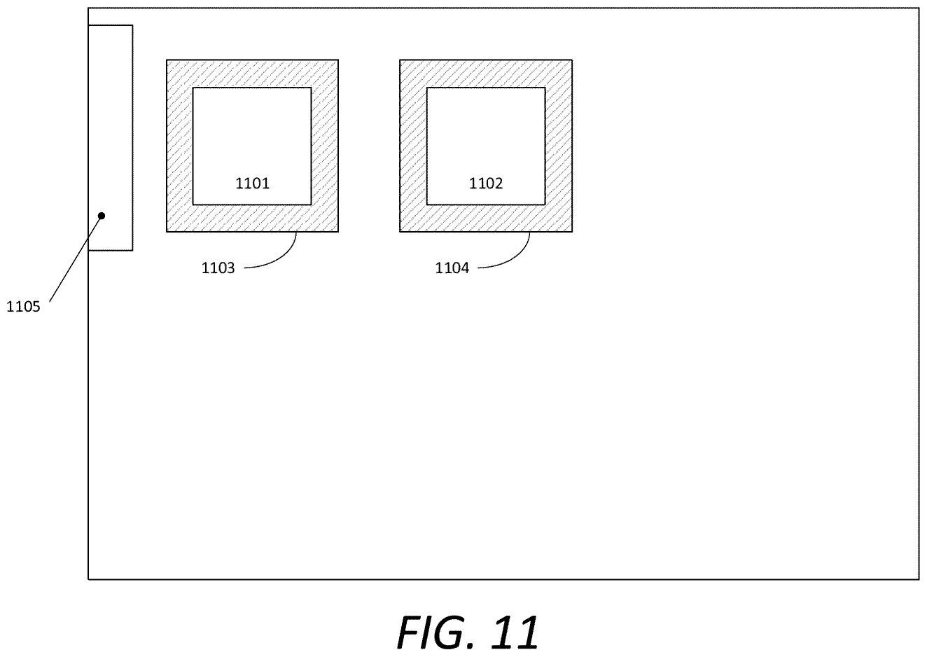

FIG. 11 includes a new aspect of the present design, namely the use of graphite foam or even graphene foam. Graphite foam was developed by ORNL and provides heating advantages at a much lighter weight. The benefit of graphite foam is a lighter weight device. Such foam is typically less than one quarter of the weight of aluminum or copper heat sinks providing the same or similar cooling capacity. Heat sinks operate by drawing heat away from the components through the heavy metal components whereupon the system directs air or water toward the metal and away from the metal to remove or decrease heat. Graphite foam is used to shield or insulate the heat from the components, and an open area may be provided such that the foam shields the component, such as a laser diode, from other components in the system.

FIG. 11 is a top view of the arrangement representing one embodiment of the use of graphite foam. Laser diodes 1101 and 1102 are provided, with graphite foam shown as squares or rectangles around laser diodes 1101 and 1102. Graphite foam structures 1103 and 1104 insulate the heat produced by laser diodes 1101 and 1102 such that heat flows in an upward and not lateral direction. Optional fan 1105 may be provided to direct air over the laser diodes and graphene foam structures 1101-1104 and out of the system. Other arrangements of the graphite foam may be provided.

### Audio Processing

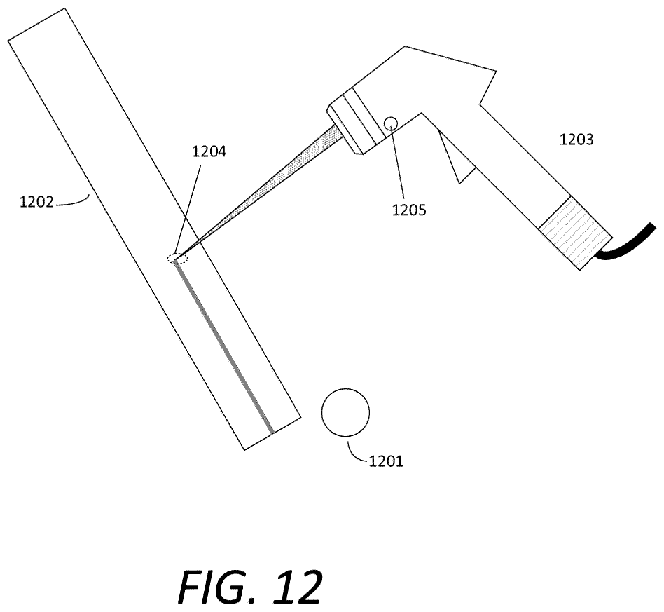

The present design may alternately or additionally include audio processing as an added safety feature. Such a design includes an audio receiver that may be located beneficially as near as possible to the welding site. FIG. 12 illustrates a simplified representation of the present design. One embodiment of this aspect of the design includes an audio receiver 901 near the weld or workpiece 1202. Audio receiver 1201 may be a microphone provided in the gun or welding torch 1203, which may be connected to the system as depicted herein. Alternately positioned audio receiver 1205 may be in line or otherwise proximate the shield gas tubing in a position relatively close to the welding torch. Plume 904 is also shown in this view. It is understood that audio receiver 1201 may be placed anywhere the device can receive sound from the weld. At a minimum, sound of a quietest weld in view of the configuration employed must be audially received by audio receiver 1201 irrespective of the type of audio receiver employed. The system will in most if not all cases respond more robustly the closer audio receiver 1201 is to the welding spot or point.

The sound of a laser generated weld is significantly different from other sounds encountered while welding. The system may compare audio received to a known audio profile, or a predetermined quantity including but not limited to frequency, amplitude, decibels, or other sound quantity. The system detects a difference between the sound received and the reference sound or sound level or sound profile to determine an unsafe condition. The controller may then turn off the laser in the presence of an unsatisfactory condition.

Additionally, laser welding introduces a wobble to the weld, representing controlled oscillations in the laser beam's path. The wobble is a dynamic movement that provides an increase in weld seam width. The result is increased penetration and distribution of heat and a minimization of defects. When employing a wobble in the current design, the result is a very distinct sound profile tied to the wobble frequency and wobble width. Wobble in this scenario results in an audible profile emanating from the weld site. The system can detect the resultant sound using audio receiver 1201 and determine if the weld is proceeding. The system and controller can use the resultant sound to determine irregularities or imperfections in the weld. Experienced laser welder personnel can determine weld quality simply by listening to the sound from the wobble function. If the wobble sound is missing, the beam is not striking the target workpiece and as a result, the controller may turn off the beam.

If the fiber laser employs PWM (Pulse Width Modulation), the on/off process of the beam also creates a unique sound when welding as a result of the PWM modulation rate. Such a sound can be characterized as a “pinging” type sound. The PWM sound frequency and amplitude, and general sound characteristic, significantly differs when the system is not performing a weld. The system may assess sound as disclosed herein and may turn off the weld when a weld is expected in the absence of the PWM audio profile.

In operation, when a user starts a weld, the system may emit a short beam pulse, such as in the millisecond range or smaller. When the pulse strikes the target, the sound differs from when the pulse fails to hit the target. Again, the controller may use sound profiles or expected levels, such as amplitude, frequency, etc. to assess whether the pulse has struck the target. If no such sound occurs or it the sound materially differs from expected, the controller may cease or inhibit starting of the weld.

The fiber laser creates a plume of vaporized metal when in operation. Modulation of the laser beam causes the vaporized metal to expand and/or contract depending on the modulation of the beam, resulting in an audio signal. The system may monitor the audio signal and sound profile and determine whether the weld is progressing and/or valid and may turn off the beam if the audio profile is unacceptable.

Further, PWM modulation may cause the plume to also modulate in size creating sound waves corresponding to modulation frequency. The system can monitor sound if sound ceases, the weld is no longer valid, and the system can stop the incident beam.

Various combinations of the foregoing sound or audio assessments may be employed and may be augmented by visual assessments. For example, both plume visual and audio attributes may be monitored and if one or the other indicates inadequate conditions for welding, the controller may turn off laser power. The foregoing audio functionality may alternately employ an accelerometer, such as attached to the welding gun or otherwise proximate the workpiece, in place of a microphone.

### Improved Lens Performance

The system transmits the laser beam through a flexible optical fiber that delivers the beam to a series of lenses that focus the beam on the work surface. Such lenses are designed for and used in a handheld laser device or gun that focuses the laser beam and these lenses are typically located several centimeters from the tip of the laser gun. The system steers the laser beam inside the laser gun using one or possibly two galvanometers to provide either a line or a two-dimensional pattern rather than a single point. The width of the line/pattern determines the width of the weld.

The concentrated laser beam rapidly heats and melts the metal at the weld joint and the small beam size allows for deep penetration with minimal heating of the surrounding material. As the laser beam moves along the metal it creates a molten pool of metal that fuses the workpieces together. The ability to precisely control the laser beams power, size and focal point greatly increases the quality of the weld with minimal distortion to the rest of the metal.

Typically, the handheld gun contains a nozzle that is used to direct a shielding gas (such as argon or nitrogen) around the welding area to protect the weld from contamination and oxidation, similar to known MIG or TIG welding processes. The final protective lens is a piece of glass or quartz or transparent material at the wavelength of the laser beam that acts as a barrier to prevent fumes, dust and weld splatter from entering the laser gun. In operation, the beam passes through the center or very near the center of the protective lens. Many common laser guns have multiple protective lenes in line with the beam being transmitted. These lenses become dirty from the outside of the gun and the resultant dirt that builds up over time absorb a portion of the laser beam. Such absorption heats the lens causing distortion and cracking, and eventually the glass or quartz protective lens can become opaque. Once this degradation begins, heat to the laser gun increases as heat transfers from the protective lens to the rest of the laser gun. Additionally, the beam exiting the gun provides less energy and beam focus degrades, adversely affecting the weld. Protective lens degradation can be a gradual process but can occur quickly in dirty environments. The typical life span of this protective barrier lens can be from just a few minutes to many hours depending on the laser power, the pieces being welded, and the environment.

This protective barrier lens has typically been employed with the laser beam passing through the center of the protective lens rendering the lens essentially useless once dirty. The present design offsets the protective lens such that that laser beam goes through the protective lens at an off-center position. As the lens becomes dirty or begins to absorb laser energy and heats up, the system rotates the protective lens a few degrees to put an unused and clean virgin part of the lens in front of the beam, extending the life of the lens. Rotation may be accomplished manually or automated by the system. Automated rotation may entail detecting the gun/lens heat level using a temperature sensor proximate the protective lens or even the reflected energy off the barrier lens. Alternately, it is known that as the protective lens becomes dirty or more opaque, the lens will reflect more of the laser beam back into the laser gun. An automated aspect of the present design includes detecting laser beam reflection back from the protective lens by use of a light sensor positioned inside the laser gun, behind or away from the exterior of the laser gun. A further embodiment of the present design automates rotation of the protective lens by detecting beam scattering through the protective lens or just outside the lens using an optical sensor.

Any or all of these automated solutions may employ sensors connected to a control apparatus or controller set to sense degradation and hardware configured to rotate the protective lens when the lens is detected to be problematic or potentially degrading. Once a lens has been rotated to an unacceptable area, i.e., an area wherein the beam passing through is determined to cause heat to the gun, the system via the controller may transmit a warning or alarm, visual or audible, such that the operator may stop welding, investigate the issue, and potentially clean or replace the protective lens.

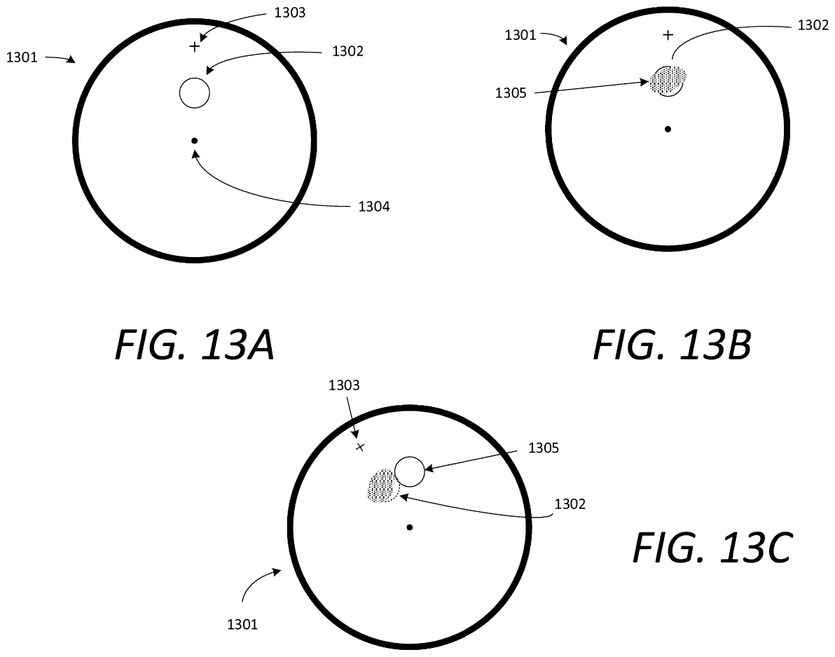

FIG. 13A illustrates an example of transmission through protective barrier lens 1301. While shown as a circle in this representation, protective lens 1301 may take any shape or form, including but not limited to square, rectangular, oval, and so forth. Top center point 1303 is shown as well as energy region 1302, representing the area where the laser beam passes through protective lens 1301. Center point 1304 of protective lens 1301 is the point about which protective lens 1001 rotates and the point where the traditional laser beam would pass through or be centered upon. FIG. 13B illustrates protective lens 1301 with spot 1305 represented, where spot 1305 represents dirt or other lens degradation and covers part or all of energy region 1302. Such obscuration or degradation may result in rotation of protective lens 1301 into an orientation such as that shown in FIG. 13C. FIG. 13C illustrates the post rotation orientation in one aspect, with spot 1305 rotated as is top center point 1303. New passthrough region 1306 is the region where laser light energy passes through protective lens 1301.

Rotation hardware may be provided to maintain the protective barrier lens. Such rotation hardware may include, in the case of a circular protective barrier lens, a toothed ring configured to maintain the protective barrier lens, such as using a gasket or other holding ring where teeth on the exterior of the toothed ring allow turning manually by the user or automatically by the gun, such as a small driven complementary toothed gear. Other rotation means may be provided such as a manually engageable ring that is engageable from an exterior of the laser gun. Alternately, a direct drive wheel may be employed that contacts a ring type lens holder or a belt or other drive or rotation design may be employed. The ring or wheel containing the protective lens may rotate at least partially within a track in order to maintain the protective lens in a desired orientation while rotating. Amount of rotation may vary and may be provided by the user or automatically. If rotation results in another obstructed view through protective barrier lens 1301, the user or system may provide further rotation. Additionally, the system may employ a simple rack and pinion type design that may be lockable, where the user may rotate the lens by moving the linear “rack” to rotate the “pinion” which may be a gear having the lens positioned inside the inner periphery of the gear. The beam would initially pass through an off-center position on the lens and if degraded, the user could linearly move the “rack” to a different portion of the lens. Other types of rotating mechanical devices may be provided, including but not limited to cam mechanisms, scotch yokes, and rotary actuators.

### Enhanced Functionality

In one embodiment of the present design, there may be provided a dual mode trigger on the laser gun. The first mode is caused by pressing the trigger on the laser gun to a first position, causing laser energy emission and welding. Pressing the trigger to a second position initiates wire feed. Either pressing to the second position or a third position provides both wire feed and laser energy. If, for example, the user simply wants to feed wire, the second position may do only that, and pushing to the third position causes both wire feed and energy application. Thus the present design may include a dual mode trigger and dual mode trigger functionality.

A further aspect of the present design includes a “guide” on or near the tip of the laser gun, where the guide may be a passive wheel or a driven wheel, referred to as a guide wheel, that contacts the welding piece and serves to guide the user and the laser gun along the surface or surfaces to be welded. If the system employs a driven wheel, the system drives the wheel, which is fixedly attached to the laser gun but is free to rotate in order to contact and move along the workpiece at a desired rate of speed to facilitate providing a stable and clean weld. Desired rate of speed may be determined by based on wire feed, wire thickness, plate thickness, plate materials, aggressiveness of weld desired, and so forth. If the guide is a passive wheel that is not driven but is fixedly mounted to the laser gun, the passive guide wheel helps to keep the laser gun welding in a straight line.

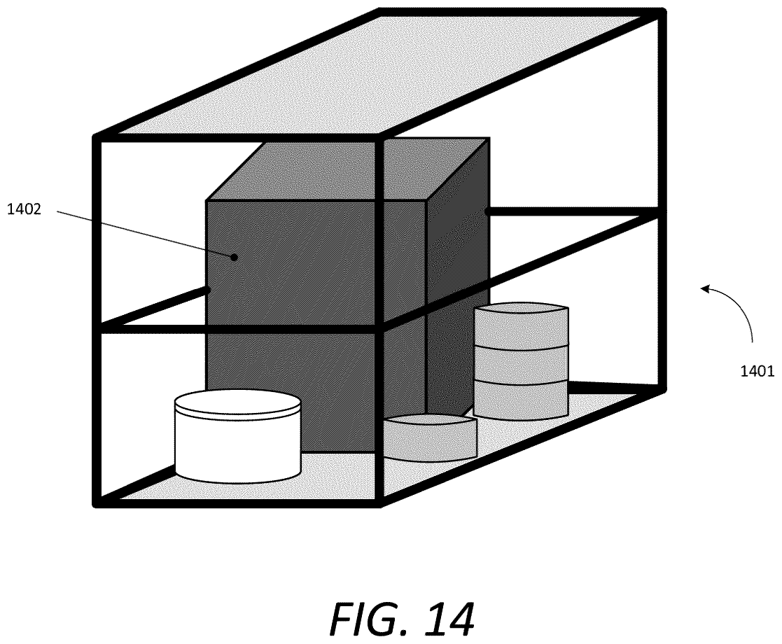

In one embodiment, rather than using extensive external packaging materials including metal and wood supports, and so forth, the present design may include a laser cart usable as a shipping container as well as a cart to maintain and transport the laser system when being used. The cart is generally cuboid or rectangular prism shaped and can include components and/or spare parts, such as wheels, cables, the laser gun, manuals, and so forth, as well as the laser generation hardware. The cart may include a top level or surface that is flat such that the laser welding apparatus can rest thereon. When shipped, the exterior of the cart serves as a framework and outer packaging, such as cardboard or other appropriate material, may be provided. Such an arrangement allows the critical laser components to be protected during shipping using the cart as a container, where the cart is shipped mostly assembled, reducing the cost of shipping. FIG. 14 illustrates one embodiment of the cart 1401 useful as a shipping container with components including component 1402 provided therein.

Further, the present system may include a programmable start and stop weld process that allows for programmable controls such as starting the weld by trigger actuation, and controlling the time that gas flow begins prior to the start of the weld, providing a default or selectable starting weld power level, a time to hold starting weld power before ramping to full power, and a ramp up time to achieving full power. Control may also be provided for stopping the weld, such as by deactuating a trigger on the laser gun, such as by releasing the trigger, stopping the wire feed immediately. If desired, the system can retract the wire a predetermined distance. Other programmed attributes may include the time the laser stays on after the trigger is released to ensure the wire has melted and can be retracted, ramping down time to a lower power over a desired period of time, a lower power setting, a time to hold the lower power setting before shutoff, and a time to hold the gas flowing after trigger release or deactuation.

Further attributes of the system may include controlling the number of ON pulses that occur while pulse welding when the operator or user actuates the trigger. For example, if pulse width modulation (PWM) is eighty percent and the PWM Frequency is 1 Khz, a setting of 800 pulses would take one second. The operator may then actuate the trigger for the next second, causing the system to generate 800 laser pulses and stop. The system does not transmit pulses until the operator deactuates the trigger and begins the actuation/deactuation sequence again.

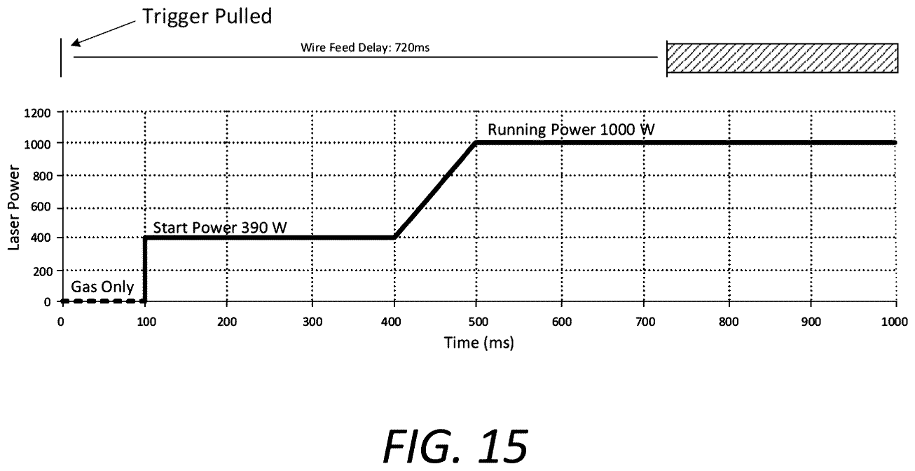

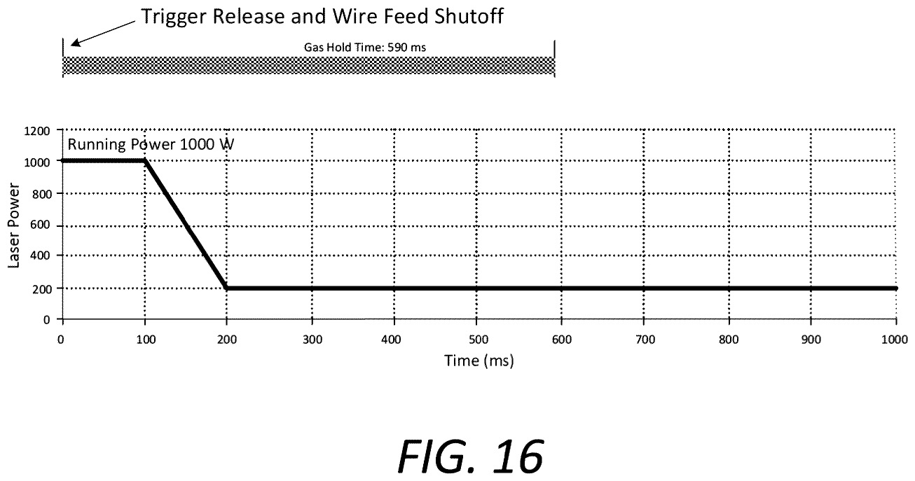

FIGS. 15 and 16 illustrate programmed aspects of the present design. These representations graphically show startup beam power and time associated with the relevant power output (FIG. 15) and stopping beam power and times associated therewith (FIG. 16). From FIG. 13, at the start of the weld, once the user activates the trigger, the system provides gas. At approximately 100 milliseconds, the laser initiates at a power level of 39 W. 300 milliseconds later, at total time of 400 milliseconds, the laser begins to ramp up to 1000 W, reaching 1000 W 100 milliseconds later, at total time 500 milliseconds. In this scenario, the user initiates wire feed engagement, which may be by activating the same trigger, which in this instance occurs at 720 milliseconds. At this point, the system commences wire feed. Such programmable functionality is novel. FIG. 16 shows operation upon user release of the trigger. Power down from 1000 W begins at 100 milliseconds and reaches 200 W at 200 milliseconds, stays at 200 W for 100 additional milliseconds, then decreases to zero at total time 300 milliseconds from trigger deactivation. The gas hold time in this configuration is for 590 milliseconds from trigger deactivation.

Operation is thus programmable for virtually any rise time, rise rate, fall time, fall rate, and power level maintenance period, i.e. a period where the power level is to be held constant at a zero or nonzero level. Times may change for different welds and/or multiple rise, fall, and constant power values or zones may be provided in a single weld profile. In this manner, a user may provide virtually any type of power profile for a desired weld over a given time period.

### Quick Release Wire Feed

The present design further includes a removable wire-feeder assembly for a handheld laser welding gun. The removable wire feed assembly includes an adapter configured to mount over the existing downward-projecting tab on a laser welding gun, a slotted tongue formed as part of the adapter to receive a quick-release shaft, a cam-lock quick-release mechanism enabling rapid attachment and detachment of the wire-feeder tip assembly, a tip support bracket configured to hold the wire-feeder nozzle in its operational alignment relative to the laser gun's output nozzle, and a cable quick-disconnect coupling, allowing the removable feeder assembly's Bowden tube to be connected to or disconnected from the integrated Bowden tube inside the laser gun cable bundle. The assembly allows the operator to remove the entire wire-feeder tip structure within seconds, eliminating obstruction during non-wire welding operations.

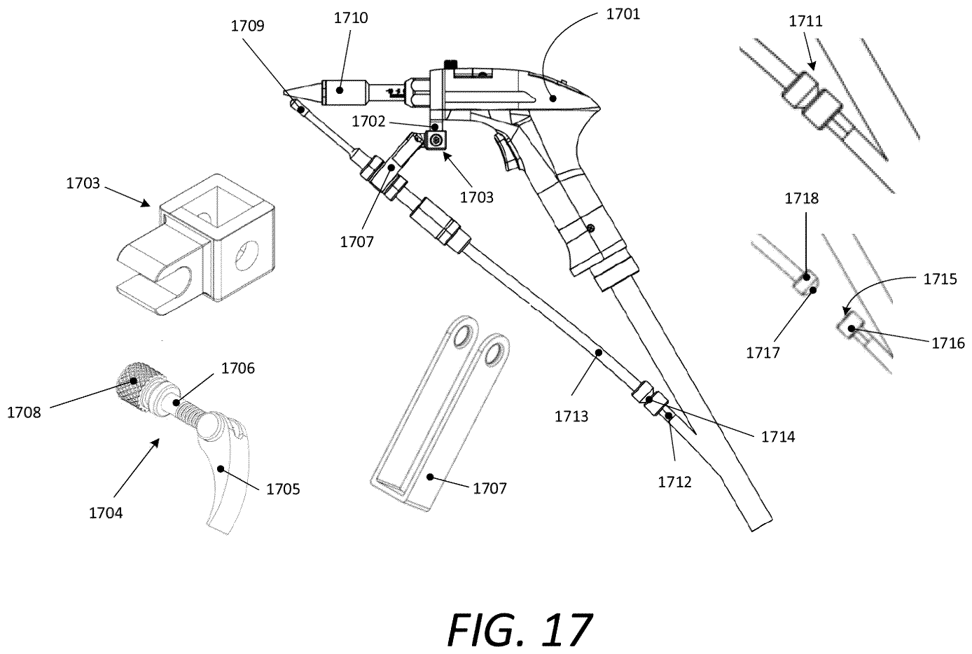

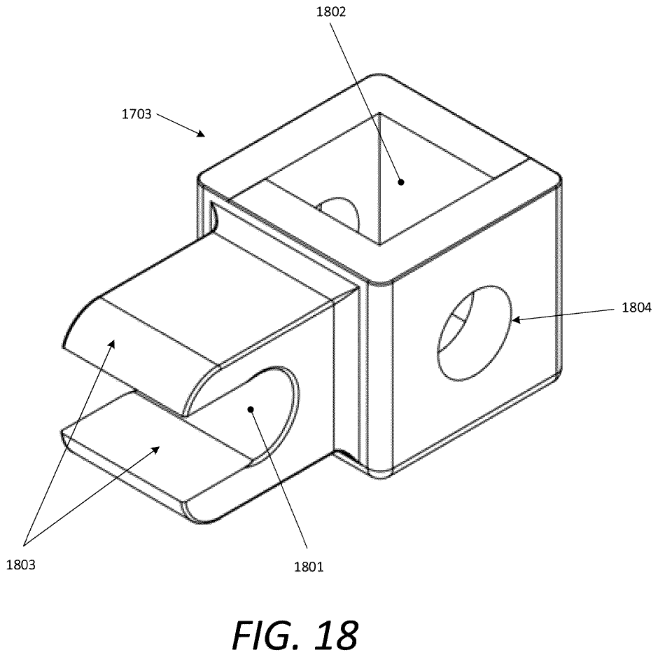

FIG. 17 illustrates aspects of the modular and removable wire-feeder assembly for a handheld laser welding gun 1701. The handheld laser welding gun 1701 typically includes a downward-projecting metal tab 1702 used for conventional wire-feeder mounting. The current design includes adapter 1703 configured to slide over and clamp onto downward-projecting metal tab 1702. Adapter 1703, shown in more detail in FIG. 18, may include a U- or C-shaped mounting passage 1801, a through-hole 1802 that receives downward-projecting metal tab 1702, a forward-facing projecting tongue set 1803, and transverse slot 1804 configured to receive quick-release shaft 1706. Adapter 1703 remains semi-permanently attached to the gun.

The present design also includes quick-release mechanism 1704 to attach the wire-feeder tip assembly to adapter 1703. Quick release mechanism 1704 includes cam-operated lever 1705, quick release shaft 1706 passable through transverse slot 1804 and the tip support bracket 1707. The mechanism further includes threaded nut or clamp block 1708. When the user flips cam-operated lever 1705 into a locked position, cam action clamps tip support bracket 1707 securely. When lever 1705 is flipped open, shaft 1708 clears pressure and the support bracket 1706 slides free of the adapter 1703. Such an apparatus enables attachment and detachment without tools.

Tip support bracket 1707 mounts wire-feeder nozzle 1709 to the quick-release shaft 1706. Tip support bracket 1707 maintains axial alignment between wire-feeder nozzle 1709 and laser welding head 1710. The present design also includes a Bowden cable quick-disconnect arrangement 1711, wherein a Bowden cable carrying filler wire is divided into two sections, fixed section 1712 integrated into the main cable bundle (not shown in this view) and removable section 1713 attached to the wire-feeder assembly. Quick-disconnect coupling 1714 joins the two. The coupling may include cylindrical housing 1715, male connector 1716, female connector 1717, and self-centering or keyed interface 1718. This quick disconnect coupling arrangement 1711 allows rapid connection or disconnection of the Bowden cable when attaching or removing the assembly to or from gun 1701.

In operation, the user attaches the wire-feeder assembly, inserts the Bowden coupling 1711 to join the two cable sections, slides tip support bracket 1707 onto the adapter tongue set 1805, passes quick-release shaft 1706 through the aligned openings, and flips the cam-lever 1705 into the locked position. To remove, the user flips the cam-lever 1705 to release shaft 1706, slides tip support bracket 1707 off adapter 1703, and disconnects the Bowden coupling 1711. The entire removal process by either a professional or an amateur may require less than five seconds.

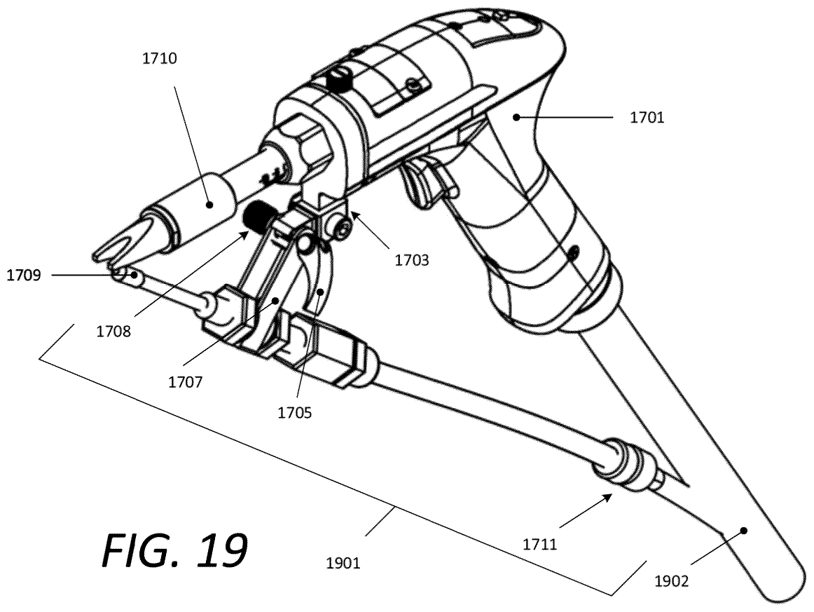

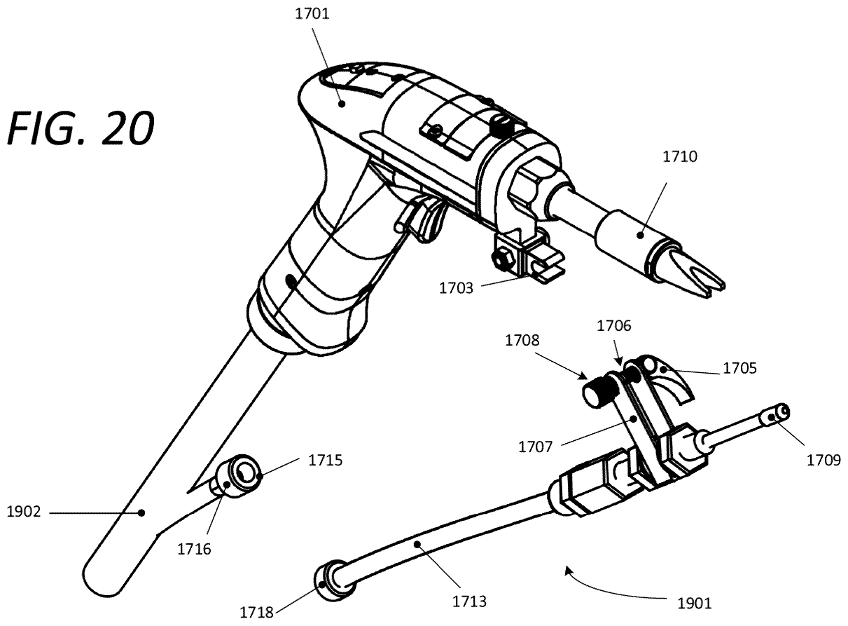

FIG. 19 presents the quick release hardware secured and in place, while FIG. 20 shows the quick release hardware removed from the laser welding gun after a quick release procedure. Wire feed hardware 1901 includes various components with a tube passing through components, where components may include the tip and abutting elements sized to fit on either side of support bracket 1707. Y-shaped element 1902 is provided in this embodiment and is connectable to handheld laser welding gun 1701 and wire feed hardware 1901. Gas flows to handheld laser welding gun 1701 and wire passes to wire feed hardware 1901 through Y-shaped element 1902.

In the foregoing description, terms such as “workpiece” or “workpiece arrangement” are intended broadly to represent any combination of piece or pieces and/or any target of welding. As welding can entail fastening one piece to another, the term “workpiece” or “workpiece arrangement” used herein may represent a joint between two pieces, for example, or a single piece.

According to one embodiment of the present design, there is provided a laser welding system for welding a target workpiece arrangement comprising a laser beam transmitter configured to transmit a laser beam at an energy level, a guide beam transmitter configured to transmit a guide beam, a sensor configured to sense guide beam light transmitted by the guide beam transmitter and reflected from the target workpiece arrangement, and a controller configured to decrease the energy level of the laser beam when the sensor senses the guide beam light received at a time greater than a threshold acceptable time level.

This embodiment of the laser welding system may employ an optional guide beam transmitter configured to transmit a guide beam, and in the absence of such a guide beam transmitter or with such a transmitter present, the system may include a sensor configured to sense welding laser light, as opposed to guide beam light, transmitted and reflected from the target workpiece arrangement.

According to a further embodiment, there is provided a laser welding system for welding a target workpiece arrangement comprising a laser beam transmitter configured to transmit a laser beam at an energy level, a sensor configured to sense an attribute of the target workpiece arrangement when exposed to one of the laser beam transmitted toward the target workpiece arrangement and an energy emission transmitted toward the target workpiece arrangement, and a controller configured to decrease the energy level of the laser beam when the sensor senses the attribute having a value below a threshold attribute level. The controller is further configured to decrease the energy level of the laser beam irrespective of physical contact between the laser beam transmitter and the target workpiece arrangement.

According to another embodiment of the present design, there is provided a laser welding system comprising a laser beam transmitter configured to transmit a laser beam at an energy level toward a workpiece arrangement, a sensor configured to sense an attribute of the target workpiece arrangement when the target workpiece arrangement is exposed to one of the laser beam contacting the target workpiece arrangement, and an energy emission transmitted toward the target workpiece arrangement, and a controller configured to decrease the transmission energy level of the laser beam transmitter when the sensor senses the attribute at a outside an acceptable threshold window. The controller is further configured to decrease the energy level of the laser beam irrespective of physical contact between the laser beam transmitter and the target workpiece arrangement.

According to an additional embodiment of the present design, there is provided a laser welding system for welding a target workpiece arrangement, comprising a laser beam transmitter configured to provide a laser beam, a rotatable reflective surface configured to receive the laser beam and direct the laser beam toward the target workpiece arrangement, and a controller configured to provide a triangular wave control command controlling the rotatable reflective surface to rotate and reflect laser energy toward the target workpiece arrangement in a triangular wave pattern.

According to a further embodiment, there is provided a laser welding system for welding a target workpiece arrangement comprising a laser beam transmitter configured to provide a laser beam a rotatable reflective surface configured to receive the laser beam and direct the laser beam toward the target workpiece arrangement, and a controller configured to provide a triangular wave control command controlling the rotatable reflective surface to rotate and reflect laser energy linearly in a back and forth manner toward the target workpiece arrangement.

According to another embodiment, there is provided a laser beam transmission system comprising a plurality of laser diodes and an arrangement of graphene foam positioned proximate at least one laser diode.

According to yet another embodiment, there is provided a laser welding system for welding a target workpiece arrangement, comprising a laser beam transmitter configured to provide a laser beam, an audio receiver, and a controller configured to receive audio signals from the audio receiver, compare said audio signals with a predetermined audio profile, and command the laser beam transmitter from transmitting the laser beam when the comparison indicates the laser beam is not adequately striking the target workpiece. In one embodiment, the laser welding system further comprises a visual sensor configured to sense a visual attribute associated with the laser beam including but not limited to a plume or presence or absence of the workpiece and turn off the laser transmitter when the controller determines the visual attribute is deficient.

According an additional embodiment of the present design, there is provided a laser welding system for welding a target workpiece arrangement comprising a laser transmitter configured to provide laser energy and a laser welding head configured to receive the laser energy from the laser transmitter and provide a laser beam toward the target workpiece arrangement. The laser welding head comprises a protective barrier lens and the laser welding head is configured to provide the laser beam through a noncentered position of the protective barrier lens.

According to a further embodiment of the present design, there is provided a laser welding system for welding a target workpiece arrangement comprising a laser transmitter configured to provide laser energy, a controller configured to control laser energy transmission, and a laser welding head configured to receive the laser energy from the laser transmitter and commands from the controller and provide a laser beam toward the target workpiece arrangement. The laser welding head comprises a protective barrier lens and the laser welding head is configured to provide the laser beam through an offset from center position of the protective barrier lens.

According to another embodiment, there is provided a laser welding system for welding a target workpiece arrangement comprising a laser transmitter configured to provide laser energy, a wire feed mechanism, and a laser welding gun configured to receive the laser energy from the laser transmitter comprising a dual mode trigger configured to control transmission of a laser beam from the laser welding gun and control feeding of wire by the wire feed mechanism.

According to a further embodiment, there is provided a quick release wire feed mechanism for use with a welding gun, comprising an adapter configured to fit with and connect to a tab provided on the welding gun, wherein the adapter comprises a C-shaped or U-shaped tongue arrangement configured to receive a shaft, a support bracket configured to fit with the adapter, and a cam lock release mechanism comprising the shaft, the cam lock release mechanism configured to secure the support bracket to the adapter using the shaft. The support bracket connects to wire feed hardware connected to a first removable Bowden cable connected to a fixed Bowden cable by a Bowden coupling.

According to a further embodiment, there is provided a quick release wire feed mechanism for use with a welding gun, comprising a shaft, an adapter configured to fit with and connect to a tab provided on the welding gun, wherein the adapter comprises at least one open region configured to receive the shaft, a support bracket configured to fit with the adapter and maintain wire feed hardware, and a release lever attached to the shaft, the release lever and the shaft configured to secure the support bracket to the adapter.

The feed hardware is joinable to a first removable cable connected to a fixed cable by a coupling, and the mechanism comprises a tightening element configured to secure the adapter to the tab. The shaft comprises an end piece, wherein the shaft fits through openings in the support bracket and within a first open region in the adapter, enabling fixing the shaft in the first open region and securing the support bracket to the adapter. The wire feed hardware comprises a tubular member configured to receive wire, the tubular member passing through abutting elements positionable adjacent sides of the support element. The release member comprises a cam tightening element joined to the shaft and configured to draw the shaft forward when engaged and release tension on the shaft when disengaged. The mechanism may also include a Y-shaped element joined to the welding gun, wherein one branch of the Y-shaped element joins to the coupling and another branch of the Y-shaped element receives gas and passes the gas to the welding gun.

According to an additional embodiment, there is provided a quick release wire feed mechanism for use with a welding gun having a tab on a bottom side, comprising an adapter comprising a C or U shaped region, the adapter configured to fit with and connect to the tab, a support bracket configured to fit with the adapter and maintain wire feed hardware, and a release mechanism comprising a shaft having an end and a release lever attached to the shaft, the release lever when engaged configured to pull the end of the shaft, securing the support bracket to the adapter.

According to a further embodiment, there is provided a quick release wire feed mechanism joinable to a tab on a welding gun comprising an adapter configured to fit with and connect to the tab, the adapter comprising a C or U shaped region, a support bracket configured to fit with the adapter and maintain wire feed hardware, and a cam release mechanism comprising a shaft configured to fit within the C or U shaped region and a release lever having an end element affixed thereto, the release lever and the shaft configured to releasably secure the support bracket to the adapter.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A quick release wire feed mechanism for use with a welding gun, comprising:
a shaft;
an adapter configured to fit with and connect to a tab provided on the welding gun, wherein the adapter comprises at least one open region configured to receive the shaft;
a support bracket configured to fit with the adapter and maintain wire feed hardware; and
a release lever attached to the shaft, the release lever and the shaft configured to secure the support bracket to the adapter.

2. The quick release wire feed mechanism of claim 1, wherein the feed hardware is joinable to a first removable cable connected to a fixed cable by a coupling.

3. The quick release wire feed mechanism of claim 1, further comprising a tightening element configured to secure the adapter to the tab.

4. The quick release wire feed mechanism of claim 1, wherein the shaft comprises an end piece, wherein the shaft fits through openings in the support bracket and within a first open region in the adapter, enabling fixing the shaft in the first open region and securing the support bracket to the adapter.

5. The quick release wire feed mechanism of claim 2, wherein the wire feed hardware comprises a tubular member configured to receive wire, the tubular member passing through abutting elements positionable adjacent sides of the support element.

6. The quick release wire feed mechanism of claim 1, wherein the release member comprises a cam tightening element joined to the shaft and configured to draw the shaft forward when engaged and release tension on the shaft when disengaged.

7. The quick release wire feed mechanism of claim 2, further comprising a Y-shaped element joined to the welding gun, wherein one branch of the Y-shaped element joins to the coupling and another branch of the Y-shaped element receives gas and passes the gas to the welding gun.

8. A quick release wire feed mechanism for use with a welding gun having a tab on a bottom side, comprising:
an adapter comprising a C or U shaped region, the adapter configured to fit with and connect to the tab;
a support bracket configured to fit with the adapter and maintain wire feed hardware; and
a release mechanism comprising:
a shaft having an end; and
a release lever attached to the shaft, the release lever when engaged configured to pull the end of the shaft, securing the support bracket to the adapter.

9. The quick release wire feed mechanism of claim 8, wherein the wire feed hardware connects to a first removable cable connected to a fixed cable by a coupling.

10. The quick release wire feed mechanism of claim 8, further comprising a tightening element configured to secure the adapter to the tab.

11. The quick release wire feed mechanism of claim 8, wherein the shaft fits through openings in the support bracket and within the C or U shaped region of the adapter, fixing the shaft and securing support bracket to the adapter.

12. The quick release wire feed mechanism of claim 9, wherein the wire feed hardware comprises a tubular member configured to receive wire, the tubular member passing through abutting elements positionable adjacent sides of the support element.

13. The quick release wire feed mechanism of claim 8, wherein the release member comprises a cam tightening element joined to the shaft and configured to draw the shaft forward when engaged and release tension on the shaft when disengaged.

14. The quick release wire feed mechanism of claim 9, further comprising a Y-shaped element joined to the welding gun, wherein a first branch of the Y-shaped element joins to the coupling and a second branch of the Y-shaped element receives gas and passes the gas to the welding gun.

15. A quick release wire feed mechanism joinable to a tab on a welding gun, comprising:
an adapter configured to fit with and connect to the tab, the adapter comprising a C or U shaped region;
a support bracket configured to fit with the adapter and maintain wire feed hardware; and
a cam release mechanism comprising:
a shaft configured to fit within the C or U shaped region; and
a release lever having an end element affixed thereto, the release lever and the shaft configured to releasably secure the support bracket to the adapter.

16. The quick release wire feed mechanism of claim 15, wherein the support bracket is joinable to wire feed hardware connected to a first removable cable connected to a fixed cable by a coupling.

17. The quick release wire feed mechanism of claim 15, wherein the shaft fits through openings in the support bracket and within the C or U shaped region of the adapter, enabling the cam release mechanism to secure the support bracket to the adapter.

18. The quick release wire feed mechanism of claim 16, wherein the wire feed hardware comprises a tubular member configured to receive wire, the tubular member passing through abutting elements positionable adjacent sides of the support element.

19. The quick release wire feed mechanism of claim 15, wherein the release lever is joined to the shaft and configured to draw the shaft forward when engaged and release tension on the shaft when disengaged, enabling release of the wire feed hardware.

20. The quick release wire feed mechanism of claim 16, further comprising a Y-shaped element joined to the welding gun, wherein a first branch of the Y-shaped element joins to the coupling and a second branch of the Y-shaped element receives gas and passes the gas to the welding gun.
